(19) United States
(12) Patent Application Publication
(10) Pub. No.: US 2023/0272228 A1
(43) Pub. Date: Aug. 31, 2023

(54) FIRE PROTECTION COMPOSITION

(71) Applicant: SHERWIN-WILLIAMS COATINGS DEUTSCHLAND GMBH, Wuppertal (DE)

(72) Inventors: Jochen GROTZINGER, Schwabisch Gmund (DE); Andreas ROTHENGASS, Goppingen (DE); Johannes VIERTEL, Vaihingen (DE); Markus WOHR, Illingen (DE)

(21) Appl. No.: 17/998,402

(22) PCT Filed: May 12, 2021
(86) PCT No.: PCT/EP2021/062770

§ 371 Date: Nov. 10, 2022

(30) Foreign Application Priority Data
May 14, 2020 (EP) 20174796.1

(51) Int. Cl. C09D 5/18; C09D 7/61; C09D 7/63; C09D 171/10; C09D 7/40

(52) U.S. Cl. CPC C09D 5/18; C09D 7/61; C09D 7/63; C09D 171/10; C09D 7/70

(57) ABSTRACT

The present invention relates to a fire protection composition comprising a component A and a component B. Component A comprises an epoxy liquid resin and ammonium polyphosphate. Component B comprises an adduct B1 of (i) at least one polyamine having at least three amine hydrogens reactive toward epoxide groups with (ii) at least one epoxide, an ether group-containing aliphatic primary diamine B2, and an aliphatic or cycloaliphatic primary diamine B3. The fire protection composition has good adhesion to metal, and after passing through burning-in ovens in the automotive industry still shows good fire protection values with a low mass loss and is suitable for spray application.

### TECHNICAL FIELD

The invention is based on a fire protection composition according to the preamble of the first claim.

The invention is also based on a method for coating heat-stable substrates, particularly preferably heat-stable substrates in the shell construction of transport means.

### BACKGROUND ART

In the shell construction of transport means, at the end of the shell construction, the body passes through a CDC bath (Cathodic Dip Coating), in which the latter is coated with a so-called CDC paint, which is then burnt-in in a CDC oven. A good and full-area CDC paint is a base for a long-term use of the vehicle, since it makes a significant contribution to corrosion resistance. In addition, the body additionally passes through a further oven in which the paint of the body is burnt in.

In the production of battery-operated vehicles, the containers of these batteries are provided with fire protection coatings in order to better protect the vehicle and the passengers in the event of a battery fire. However, high demands are placed on these fire protection coatings. Thus, they are intended to have good adhesion to the materials of these battery containers, which typically consist of metal, preferably without pretreatment. In addition, the fire protection coatings must not suffer any loss of quality when passing through the curing ovens and, if possible, must not exhibit any loss of mass, which would lead to an increased VOC load in these ovens. A low mass loss is typically achieved by a reduction of solvents, which, however, entails a strong increase in the viscosity of the fire protection composition. However, the latter should have a sufficiently low viscosity in order to be applied to the substrates by means of spray application. Ideally, the fire protection coatings further contribute to protection against corrosion, which would make coating with a CDC paint obsolete.

### REPRESENTATION OF THE INVENTION

The object of the invention is to provide a fire protection composition which exhibits good adhesion to the materials of these battery containers, preferably metal, still has good fire protection values after passing through curing ovens and has a low mass loss, is suitable for spray application and preferably improves the corrosion resistance of the substrates.

Surprisingly, it has been found that a fire protection composition according to claim 1 is able to achieve this object.

Further aspects form a use of the fire protection composition for coating heat-stable substrates and a method for coating heat-stable substrates.

Preferred embodiments of the invention are the subject matter of the dependent claims.

### WAYS TO IMPLEMENT THE INVENTION

In a first aspect, the present invention relates to a fire protection composition comprising a component A and a component B. Preferably, the two components A and B are present as separate components, in particular prior to use of the fire protection composition.

Component A comprises:
10-70, in particular 15-50, 15-30, preferably 15-25 wt % of at least one liquid epoxy resin having an average of more than one epoxy group per molecule A1 based on the total weight of the component A; and
10-70, in particular 20-60, 30-50, preferably 35-45 wt % ammonium polyphosphate A2, based on the total weight of the component A.

Component B comprises:
at least one adduct B1 from (i) at least one polyamine having at least three amine hydrogens reactive toward epoxide groups with (ii) at least one epoxy:
at least one aliphatic primary diamine B2 containing ether groups, in particular, this is a polyoxyalkylene diamine;
at least one aliphatic or cycloaliphatic primary diamine B3, preferably the at least one aliphatic or cycloaliphatic primary diamine B3 is free of ether groups;
preferably at least one tertiary amine B4.

The weight ratio of B1:B2:B3 is 1:1.0-2.0:1.5-3.5, in particular 1:1.2-1.8:2.0-3.0, preferably 1:1.25-1.75:2.25-2.8, particularly preferably 1:1.3-1.6:2.25-2.8.

The term “primary hydroxyl group” refers to an OH group which is bonded to a carbon atom with two hydrogens.

A “primary amino group” denotes an NH₂ group bonded to an organic radical and a “secondary amino group” denotes an NH group which is bonded to two organic radicals which together can also be part of a ring.

“Molecular weight” is understood in the present document to mean the molar mass (in grams per mole) of a molecule. “Average molecular weight” is the number average Mₙ of an oligomeric or polymeric mixture of molecules, usually determined by gel permeation chromatography (GPC) against polystyrene as a standard.

A substance or a composition is described as “storage stable” or “storable” if it can be stored at room temperature in a suitable container for a longer period of time, typically for at least 3 months up to 6 months or more, without its application or use properties being changed by storage to an extent relevant to its use. A temperature of 23° C. is referred to as “room temperature”.

The term “two-component” refers to a composition in which the constituents of the composition are present in two different components which are stored in separate containers and are only mixed with one another shortly before or during the application of the composition.

Component A comprises 10-70 wt %, in particular 15-50, 15-30, preferably 15-25 wt % of at least one liquid epoxy resin A1, based on the total weight of the component A.

The liquid epoxy resin A1 has an average of more than one epoxy group per molecule. The term “liquid epoxy resin” is well known to the epoxy specialist and is used in contrast to “solid epoxy resins”. The glass transition temperature of solid resins is above room temperature, i.e. they can be crushed into pourable powders at room temperature.

Preferred liquid epoxy resins have the formula (I)

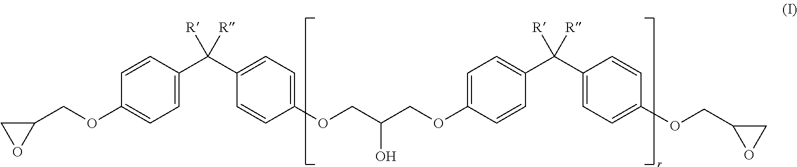

Here, the substituents R′ and R″ are each independently of each other H or CH₃. Furthermore, the Index r represents a value from 0 to 1. Preferably r is a value of less than 0.2.

These are thus preferably diglycidyl ethers of bisphenol-A (DGEBA), of bisphenol-F as well as of bisphenol-A/F. Such liquid resins are available, for example, as Araldite® GY 250, Araldite® PY 304, Araldite® GY 282 (Huntsman) or D.E.R.™ 331 or D.E.R.™ 330 (Dow) or Epikote 828 (Hexion).

Further suitable as liquid epoxy resin A1 are so-called novolaks. In particular, these have the following formula:

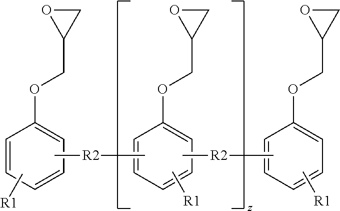

with

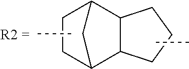

or CH₂, R1=H or methyl and z=0 to 2, in particular z=0 to 1.

In particular, these are phenol or cresol novolaks (R2=CH₂).

Such epoxy resins are commercially available under the trade name EPN or ECN as well as Tactix®556 from Huntsman or under the D.E.N.™ product line from Dow Chemical.

Preferably, the liquid epoxy resin A1 is a liquid epoxy resin of the formula (I).

Component A has 10-70, in particular 20-60, 30-50, preferably 35-45 wt % of ammonium polyphosphate A2, based on the total weight of the component A.

Preferably, the ammonium polyphosphate A2 has a particle size of 100 μm, in particular 50 μm-5 μm.

It is further advantageous if the ammonium polyphosphate A2 is an ammonium polyphosphate of the formula (NH₄PO₃)ₙ, with n being from 200-2000, preferably 600-1500.

Substance names beginning with “poly” such as polyphosphate or polyol denote substances which formally contain two or more of the functional groups occurring in their name per molecule.

Further, it may be advantageous if component A has 1-15, in particular 1-10, 2-8, preferably 2-5 wt % of at least one epoxy group-bearing reactive diluent A3, in particular selected from the group consisting of hexanediol diglycidyl ether, cresyl glycidyl ether, p-tert-butylphenyl glycidyl ether, polypropylene glycol diglycidyl ether and polyethylene glycol diglycidyl ether, based on the total weight of component A.

The epoxy-group bearing reactive diluent A3 is preferably hexanediol diglycidyl ether.

Further, it may be advantageous if component A has 1-10, in particular 5-10 wt % of at least one triaryl phosphoric acid ester or trialkyl phosphoric acid ester A4, based on the total weight of component A.

Preferably, it is a trialkyl phosphoric ester, more preferably a trialkyl phosphoric ester selected from the group consisting of trimethyl phosphate, triethyl phosphate, triisobutyl phosphate, tributyl phosphate, tris-2-chloroethyl phosphate, tris-2-ethyl-hexyl phosphate, tris-2-butoxyethyl phosphate, most preferably triisobutyl phosphate.

Further, it may be advantageous if component A has 1-10, in particular 1.5-6, preferably 1.5-3 wt % of at least one acrylate A5 having an acrylate functionality of at least 2, based on the total weight of component A.

The acrylate A5 preferably has a mean molecular weight of less than 2,500 g/mol, more preferably less than 1000 g/mol.

The acrylate A5 has an acrylate functionality of at least 2, preferably between 2 and 6, more preferably between 3 and 5, most preferably 3.

More preferably, the acrylate A5 comprises a polyfunctional acrylate having an acrylate functionality of between 2 and 6, more preferably between 3 and 5, most preferably 3, in an amount greater than 70 wt %, more than 80 wt %, more than 90 wt %, more than 95 wt % of more than 99 wt %, based on the total amount of the acrylate A5.

Preferred acrylates A5 having a functionality of 2 comprise ethylene glycol dimethacrylate, diethylene glycol dimethacrylate, triethylene glycol dimethacrylate, triethylene glycol diacrylate, tripropylene glycol dimethacrylate, 1,3-butanediol dimethacrylate, 1,4-butanediol dimethacrylate, 1,4-butanediol dimethacrylate 1,6-hexanediol dimethacrylate, neopentyl glycol dimethacrylate and polybutylene glycol dimethacrylate.

Preferred acrylates A5 having a functionality of 3 or higher comprise glycerol triacrylate, pentaerythritol triacrylate, pentaerythritol trim ethacrylate, trimethylolpropane triacrylate, trimethylolpropane trimethacrylate, tetramethylol methane tetraacrylate, di-(trimethylolpropane) tetraacrylate, pentaerythritol tetraacrylate, dipentaerythritol pentaacrylate, di pentaerythritol hexaacrylate, tri (2-methacryloyloxyethyl) trimellitate, tri (2-acryloyloxyethyl) iso-cyanurate, and ethoxylated or propoxylated derivatives thereof.

Particularly preferably, the at least one acrylate A5 having a functionality of at least 2 is trimethylolpropane triacrylate.

Surprisingly, it has been found that it can be advantageous if a component A which has A1, A2, A3, A4 and A5 in the above-described amounts, further has 0.5-15, in particular 2-5, 5-13, preferably 8-12 wt % of at least one melamine compound A6, based on the total weight of the component, A.

It is preferably a melamine compound selected from the group consisting of melamine (1,3,5-triazine-2,4,6-triamine), melamine cyanurates, melamine monophosphates, melamine polyphosphates and melamine pyrophosphates. Most preferred is melamine.

However, it can also be advantageous if the component A is entirely free of melamine compounds.

Preferably, component A has a viscosity of 1,000-10,000 mPa, in particular 3,000-10,000 mPa, especially 5,000-9,000 mPa, measured at a shear rate of 100 sec-1 at 20° C., in particular determined with a Physica MCR 301 plate-plate rheometer at 20° C., with a measuring gap of 0.5 mm according to DIN 53019-1.

Preferably, component A has components A1, A2, A3, A4 and A5, particularly in the amounts set forth above as preferred. It can be further advantageous that this component A additionally has A6 in particular in the amounts set forth above as preferred.

It is further preferred if component A consists of more than 60 wt %, more than 70 wt %, more than 75 wt %, preferably more than 80 wt %, of components A1, A2, A3, A4, A5 and optionally A6, based on the total weight of component A.

Where appropriate, component A contains other ingredients, in particular auxiliary substances and additives, for example the following:
inorganic or organic fillers, in particular ground or precipitated calcium carbonates, optionally coated with fatty acids, in particular stearates, barite (baryte), talc, quartz powders, quartz sand, micaceous iron ore, dolomites, wollastonites, kaolins, mica (potassium aluminum silicate), molecular sieves, aluminum oxides, aluminum hydroxides, magnesium hydroxide, silicas, cements, gypsums, fly ashes, carbon black, graphite, metal powders such as aluminum, copper, iron, zinc, silver or steel, PVC powders or hollow spheres;
fibers, in particular glass fibers, carbon fibers, metal fibers, ceramic fibers or plastics fibers such as polyamide fibers or polyethylene fibers;
pigments, in particular titanium dioxide and/or iron oxides;
rheology modifiers, in particular thickeners or antisettling agents;
bonding enhancers, in particular organoalkoxysilanes;
surface-active substances, in particular wetting agents, leveling agents, deaerating agents or defoaming agents;

Preferably, component A contains further auxiliary substances and additives, in particular selected from the list consisting of inorganic or organic fillers, fibers, pigments, rheology modifiers, wetting agents, leveling agents, defoaming agents, stabilizers, and accelerators.

The proportion of further auxiliary substances and additives mentioned is preferably 5-30 wt %, 10-25 wt %, 15-25 wt %, in particular 20-25 wt %, based on the total weight of the component A.

Preferably, the component A has less than 5 wt %, preferably less than 3 wt %, less than 1 wt %, less than 0.5 wt %, less than 0.2 wt %, less than 0.1 wt %, most preferably less than 0.05 wt % of organic solvents, in particular benzyl alcohol, or water, based on the total weight of the component A.

The component B comprises at least one adduct B1 from (i) at least one polyamine having at least three amine hydrogens reactive toward epoxide groups with (ii) at least one epoxy.

Preferred epoxides for such an adduct are diepoxides, such as in particular bisphenol A or F or NF diglycidyl ethers, poly-1,2-propylene oxide diglycidyl ethers or monoepoxides. Particular preference is given to aromatic monoepoxides, in particular cresyl glycidyl ethers, tert-butylphenyl glycidyl ether or the glycidyl ethers of Cardanol. Cresyl glycidyl ether is particularly preferred. Suitable cresyl glycidyl ethers are all isomeric cresyl glycidyl ethers or mixtures thereof, in particular commercially available types such as, in particular, Araldite® DY-K (from Huntsman), Polypox™ R6 (from Dow), Heloxy™ KR (from Hexion) or Erisys® GE-10 (from CVC Spec. Chem.).

The adduct is preferably prepared by slowly adding the epoxide to polyamine which has been initially introduced, wherein the temperature of the reactants is preferably kept in the range of 40 to 120° C., in particular 50 to 110° C.

Preferred are adducts of (i) at least one polyamine having at least three amine hydrogens reactive toward epoxide groups with (ii) at least one aromatic monoepoxide reacted in a molar ratio of about 1/1, in particular of 1/0.9-1.1, more preferably of 1/0.95-1.05. During the reaction, the polyamine may have been present in excess and have been removed after the reaction by means of distillation.

For such an adduct, the polyamine is preferably selected from the group consisting of ethylenediamine, 1,2-propylenediamine, 1,3-propylenediamine, 1,4-butylenediamine, 1,3-butylenediamine, 1,2-butylenediamine, 2,3-butylenediamine, 2-methyl-1,3-propanediamine, DAMP, 2,2-dimethyl-1,3-propanediamine, 1,5-pentanediamine, MPMD, 1,6-hexanediamine, 2,5-dimethyl-1,6-hexanediamine, TMD, 1,2-di-aminocyclohexane, 1,3-diaminocyclohexane, 1,4-diaminocyclohexane, IPDA, 2-methyl-1,3-diaminocyclohexane and 4-methyl-1,3-diaminocyclohexane and mixtures thereof, 1, 3-bis(aminomethyl)cyclohexane, 1,4-bis(aminomethyl)cyclohexane, 1,3-bis(aminomethyl)benzene, bis(2-aminoethyl)ether, 3,6-dioxaoctane-1,8-diamine, DETA, TETA, DPTA, N3-amine, N4-amine and BHMT.

For such an adduct, the aromatic monoepoxide is preferably a cresyl glycidyl ether.

Preferably, adduct B1 is an adduct of (i) at least one polyamine having at least three amine hydrogens reactive toward epoxide groups selected from the list consisting of ethylenediamine, propylenediamine and butylenediamine with (ii) at least one aromatic monoepoxide, particularly preferably it is an adduct of 1,2-propylenediamine with cresyl glycidyl ether.

Particular preference is given to an adduct of 1,2-propylenediamine with cresyl glycidyl ether which is prepared with an excess of 1,2-propylenediamine and subsequent removal of the excess by means of distillation. Further particularly preferred is an adduct of 1,5-diamino-2-methylpentane with cresyl glycidyl ether, which is prepared either with an excess of 1,5-diamino-2-methylpentane and subsequent removal of the excess by distillation, or with a slight excess of cresyl glycidyl ether.

Particularly preferred is an adduct of 2,2(4),4-trimethylhexamethylenediamine with cresyl glycidyl ether, which is prepared with a slight excess of 2.2(4),4-trimethylhexamethylenediamine.

The term “excess” in these particularly preferred adducts does not refer to the reactive groups, but to the molar ratio between the polyamine and the cresyl glycidyl ether.

Component B comprises at least one adduct B2 of (i) at least_one ether group-containing aliphatic primary diamine B2.

The at least one ether group-containing aliphatic primary diamine B2 is selected in particular from the group consisting of bis-(2-amino-ethyl)ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine and higher oligomers of these diamines, 3,9-bis-(3-amino-propyl)-2,4,8,10-tetraoxaspiro-[5.5]-undecane, bis-(3-am inopropyl)polytetrahydrofurans and other polytetrahydrofuran diamines and polyoxyalkylene diamines, especially polyoxyalkylene diamines.

The latter represent products from the amination of polyoxyalkylene diols and are available, for example, under the name Jeffamine® (from Huntsman), under the name polyetheramine (from BASF) or under the name PC Amine® (from Nitroil). Particularly suitable polyoxyalkylene diamines are Jeffamine®D-230, Jeffamine® D-400, Polyetheramine D 230, Polyetheramine D 400, PC Amine® DA 250 and PC Amine® DA 400.

Particularly preferred are ether group-containing aliphatic primary diamines B2 with an average molecular weight of 200-600 g/mol, especially 200-450 g/mol, particularly preferably 250-350 g/mol, especially polyoxyalkylene diamines with an aforementioned average molecular weight.

Component B comprises at least one aliphatic or cycloaliphatic primary diamine B3, preferably the at least one aliphatic or cycloaliphatic primary diamine B3 is free of ether groups.

They are aliphatic or cycloaliphatic primary diamines B3 selected in particular from the list consisting of 2,2-dimethyl-1,3-propanediamine, 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2, 2(4),4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- or 1,4-diaminocyclohexane, bis(4-aminocyclohexyl)methane (H₁₂-MDA), bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (isophorone diamine or IPDA), 2- or 4-methyl-1,3-diaminocyclohexane or mixtures thereof, 1,3-bis(aminomethyl)cyclohexane, 1,4-bis(aminomethyl)cyclohexane, 2,5(2,6)-bis(aminomethyl)bicyclo[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), 1,8-menthane diamine, 3,9-bis(3-aminopropyl)-2,4,8,10-tetraoxaspiro[5.5]undecane. These are preferably cycloaliphatic primary diamines, in particular 1,3-bis(aminomethyl)cyclohexane.

Component B preferably comprises at least one tertiary amine B4.

The at least one tertiary amine B4 is preferably tertiary amine which can accelerate the reaction between amino groups and epoxide groups.

The tertiary amine B4 is in particular a tertiary amine selected from the list consisting of 1,4-diazabicyclo[2.2.2]octane, benzyldimethylamine, α-methyl-benzyldimethylamine, triethanolamine, dimethyl-aminopropylamine, imidazoles such as in particular N-methylimidazole, N-vinylimidazole or 1,2-dimethylimidazole, salts of such tertiary amines, quaternary ammonium salts such as in particular benzyltrimethylammonium chloride, amidines such as in particular 1,8-diazabicyclo-[5.4.0]undec-7-ene, guanidines such as in particular 1,1,3,3-tetramethylguanidine and Mannich bases such as in particular 2-(dimethylaminomethyl)phenol, 2,4,6-tris-(dimethylaminomethyl)phenol.

The at least one tertiary amine B4 is particularly preferably a Mannich base, in particular 2-(dimethylaminomethyl)phenol or 2,4,6-tris(dimethylaminomethyl)phenol.

Surprisingly, it has been found that other substances which are used as accelerators for the reaction between amino groups and epoxide groups, for example acids or compounds hydrolyzable to acids, in particular organic carboxylic acids, in contrast to the tertiary amines B4 lead to a great increase in viscosity. This can be seen, for example, in Table 3 in the exchange with salicylic acid compared to Z1 with Rf.6.

The weight ratio of B1:B2:B3 is 1:1.0-2.0:1.5-3.5, in particular 1:1.2-1.8:2.0-3.0, preferably 1:1.25-1.75:2.25-2.8, particularly preferably 1:1.3-1.6:2.25-2.8.

Preferably, the weight ratio of B1:B2:B3:B4=1:1.0-2.0:1.5-3.5:0.15-1.2, in particular 1:1.2-1.8:2.0-3.0:0.3-1.0, preferably 1:1.25-1.75:2.25-2.8:0.4-0.8, particularly preferably 1:1.3-1.6:2.25-2.8:0.5-0.6. The above-mentioned weight ratios are advantageous in that a fire protection composition is thereby obtained which has a low viscosity, a low mass loss, and good values in relation to adhesion, weathering resistance and fire protection behavior.

For example, it can be seen in Table 3 that too small amounts of the adduct B1 lead to a deterioration in adhesion, weathering resistance and fire protection behavior.

It is further evident that too small amounts of ether group-containing aliphatic primary diamine B2 lead to a reduction in weathering resistance and fire protection behavior and an increase in viscosity.

It is also evident from Table 3 that too small amounts of aliphatic or cycloaliphatic primary diamine B3 lead to a reduction in fire protection behavior and an increase in viscosity.

Preferably, component B has a viscosity of 10-2,000 mPa, 50-2,000 mPa, in particular 50-500 mPa, especially preferably 20-500 mPa, measured at a shear rate of 100 sec-1 at 20° C., in particular determined with a Physica MCR 301 plate-plate rheometer at 20° C., with a measuring gap of 0.5 mm according to DIN 53019-1.

Preferably, 30 seconds after mixing component A with component B, the fire protection composition has a viscosity of 2,000-7,000 mPa, in particular 3,000-5,000 mPa, measured at a shear rate of 100 sec-1 at 20° C., in particular determined with a Physica MCR 301 plate-plate rheometer at 20° C., with a measuring gap of 0.5 mm according to DIN 53019-1.

Preferably, component B has components B1, B2, B3 and B4, in particular in the amounts set forth above as preferred.

It is further preferred if component B consists of more than 80 wt %, preferably more than 90 wt %, most preferably more than 98 wt %, of ingredients B1, B2, B3 and B4, based on the total weight of component B.

Components A and B are preferably mixed with one another in a weight ratio A:B of 100: 4-15, in particular 100: 6-10, with the aid of a mixing device.

Preferably, the stoichiometric ratio of epoxide-reactive groups to epoxide groups, in particular epoxide-reactive amine hydrogens to epoxide groups, in the fire protection composition is 0.90-1.15, in particular 0.95-1.10.

A fire protection coating obtained by applying the fire protection composition after mixing component A with component B is preferably applied to the substrate by means of a spray or extrusion device, with a brush or a roller, in particular by means of a spray or extrusion device. The layer thickness is less than 3 mm, preferably less than 2 mm, in particular 0.5 to 1.5 mm.

The combination of the properties found makes it possible, in particular, to use the composition according to the invention for a fire protection coating in coating agents that can be applied by brush, by roller or by spraying.

The fire protection coating obtained from the applied fire protection composition preferably has a layer thickness of 0.1 to 4 mm, preferably 0.3 to 2 mm, in particular 0.5 to 1.5 mm.

In a further aspect, the invention comprises a method for coating heat-stable substrates, comprising the steps of:
i) applying a fire protection composition as described above to the surface of a heat-stable substrate S1, in particular a metal substrate, particularly preferably an aluminum substrate, in order to obtain a coated heat-stable substrate S1;
ii) heating of the coated heat-stable substrate S1 to a temperature of 140-220° C., in particular of 140-200° C., preferably between 160 and 190° C., in particular for 10-60 min, particularly preferably for 20-45 min.

The step i) takes place before step ii).

In particular, the heat-stable substrate S1 is metals and plastics such as ABS, polyamide, polyphenylene ether, composites such as SMC, unsaturated polyester GFRP, epoxy or acrylate composites. Preferably, these are substrates made of metal. The preferred metals are primarily steel, in particular electrolytically galvanized, hot-dip galvanized, oiled steel, Bonazink-coated steel, and subsequently phosphated steel, and also aluminum, in particular in the variants typically occurring in automotive construction. It is particularly preferably a substrate made of aluminum.

It can be advantageous that before step i) and step ii) a step i′) is carried out, wherein the coated heat-stable substrate S1 with a CDC painting solution (Cathodic Dip Coating), in particular at a temperature between 20 and 100° C., in particular between 20 and 80° C.; preferably between 40 and 75° C., in particular for 1-15 min, particularly preferably for 1-5 min. Preferred painting solutions are described, for example, as cationic electrodeposition coatings in Römpp Chemie Lexikon, online Version, Georg Thieme Verlag, retrieved on Dec. 14, 2018.

However, in table 3 it has been found that the composition according to the invention has good corrosion resistance. Therefore, it can be advantageous, for cost and time saving reasons, if no step i′) is carried out before step i) and ii).

It can be further advantageous that before step i) the heat-stable substrate S1 does not undergo any pretreatment, in particular no mechanical pretreatment and/or pretreatment by application of an adhesion promoter composition, in particular not at the locations of the surface of the heat-stable substrate S1 on which the fire protection composition is applied in step i).

In Table 3 it has been found that the composition according to the invention has good adhesion to aluminum, in particular without the aluminum substrate having undergone a mechanical pretreatment or applying an adhesion promoter composition thereto.

It can further be advantageous that after step i) the applied fire protection coating has a layer thickness of 0.1-4 mm, preferably 0.3-2.0 mm, in particular 0.5 to 1.5 mm.

It may further be advantageous if the heat-stable substrate S1 is a body having a height of 10-60 cm, in particular 20-40 cm, a width of 50-500 cm, in particular 150-300 cm, and a depth of 50-700 cm, in particular 250-500 cm. Particularly preferably, the body is a container for batteries, in particular batteries for the drive of transport means, in particular automobiles.

It can be further advantageous that in step i) the fire protection coating is applied by means of spraying, brushing or rolling, in particular by means of spraying. Before the application of the fire-protection coating, the components A and B are preferably mixed.

In a further aspect, the invention comprises the use of a fire protection composition as described above for the coating of heat-stable substrates, in particular metal substrates, especially preferably aluminum substrates, particularly preferably of heat-stable substrates In the shell construction of transport means.

### EXAMPLES

The invention will now be explained in more detail with reference to examples. These are intended to further illustrate the invention, but in no way limit the scope of the invention.

Compositions Z1-Z4 and Rf.1-Rf.7 consisting of the ingredients in parts by weight were prepared according to the data in Table 2 and Table 3. The compositions Rf1-Rf.7 are comparative examples.

TABLE 1
Raw materials used

| | Trade name, manufacturer |
|---|---|
| Component A | |
| Liquid epoxy resin A1 | Araldite ® PY 304, Huntsman |
| Ammonium polyphosphate A2 | Exolit ® AP 422, Clanant |
| Reactive diluent A3 | Araldite ® DY-H, Huntsman |
| | Advanced Materials GmbH, |
| | Switzerland |
| Triisobutyl phosphate A4 | Lanxess AG, Germany |
| Trimethylolpropane triacrylate | BASF SE, Germany |
| A5 | |
| Melamine (1,3,5-triazine- | OCI, Netherlands |
| 2,4,6-triamine) A6 | |
| Component B | |
| Adduct B1 | Adduct of 1,2-propylenediamine |
| | with cresyl glycidyl ether |
| Diamine B2-1 | Jeffamine ® D-230, Huntsman |
| | Advanced Materials GmbH, |
| | Switzerland |
| Diamine B2-2 | Jeffamine ® D-400, Huntsman |
| | Advanced Materials GmbH, |
| | Switzerland |
| Diamine B3 | 1,3-bis(aminomethyl)cyclohexane, |
| | Itochu |
| MXDA | Aromatic primary diamine |
| Tertiary amine B4 | Mannich Base |
| Salicylic acid | Salicylic acid |

TABLE 2
Composition component A, quantitative data in parts by weight

| Component A | Wt. % |
|---|---|
| Liquid epoxy resin A1 | 18.3 |
| Ammonium polyphosphate A2 | 42.4 |
| Reactive diluent A3 | 3.1 |
| Triisobutyl phosphate A4 | 6.0 |
| Trimethylolpropane triacrylate A5 | 1.6 |
| Melamine A6 | 11.5 |
| Filler (Kaolin) | 5.8 |
| Pigment (titanium oxide) | 6.2 |
| Rheology additive | 0.7 |
| Fibers (Carbon and metal fibers) | 4.4 |
| Total | 100 |

Description Method of Mixing and Applying the Composition

The components A and B were mixed in the weight ratio 13.3:1. The two components were briefly mixed by hand, then for 30 seconds at 2000 rpm in a speed mixer and applied. The applied layer thickness on the primed automobile sheet plates was between 500 μm and 2000 μm. The wet layer thickness corresponds here to the dry layer thickness.

Component A had an EP value of 0.137 g/100 g, the component B had an amine value of 415 mg KOH/g. The stoichiometric ratio of the mixed composition was 103%.

Description Method and Analysis of Mass Loss

Composition Z1 was analyzed by thermogravimetry (TGA) using the real parameters from the burn-in cycle of an automotive manufacturer in Germany.

The following parameters were used on a vacuum-tight thermo-microbalance (TG 209 F1 Libra from Netzsch):
Start temperature: 40° C.
Heating rate: 10 K/min
End temperature: 150° C., 165° C., 175° C., 190° C. and 200° C./isothermal hold in each case 50 min)
Weight of sample taken: approx. 15 mg
Atmosphere: synthetic air
Crucible: Al₂O₃
Flow: 40 ml/min

It has been found that the composition Z1 had only a mass loss after heating of 1.6 wt % and after a subsequent isotherm of 50 minutes at 175° C. of 5.6 wt %. Similarly small values were also determined for isotherms of 150, 165, 190 and 200° C.

These low mass losses during the burning-in are advantageous for the produced value, since hardly any additional emissions are produced by the composition Z1. Products of the prior art show significantly higher mass losses.

Description Method and Analysis of Viscosity

The Viscosity was measured with a Physica MCR 301 plate-plate Rheometer at 20° C. with a measuring gap of 0.5 mm according to DIN 53019-1. The viscosity was determined at a shear rate of 100 1/sec.

The following evaluation was used in Table 3:
[symbol] ++ [symbol] =20-60 m Pas
[symbol] + [symbol] =15-100 mPas
[symbol] − [symbol] =>150 mPas

Description Method and Analysis of Corrosion Resistance

For the Corrosion Protection Test According to ISO 9227 NSS and ISO 6270-1, sample bodies were produced as follows:
Substrates used were steel plates with surface preparation Sa 2½ and a roughness depth of 50-70 μm.
Thereafter, the following tests were performed:
   Adhesive measurement according to DIN EN ISO 4624,
   Rust creepage at the scirbe according to DIN EN ISO 12944,
   Blistering (DIN EN ISO 4628-2)/rusting (DIN EN ISO 4628-3).

In the test of 480 h salt fog test and 720 h condensed water climate, the composition Z1 proved to be particularly resistant to corrosion and climate.

The following evaluation was used in Table 3:
«+»=Blistering 0 S0, rust creepage at the scirbe<3.0 mm
«-»=Blistering>0 S0, or rust creepage at the scirbe>3.0 mm

Description Method and Analysis of Adhesion

Adhesive measurement according to DIN EN ISO 4624. For this purpose, 20 mm adhesive tensile stamps were bonded to the coating surface and, after curing for 24 h at room temperature, removed using a hydraulic adhesive tensile testing machine, type Elcometer 510. The device automatically displays the adhesive tension value in MPa or N/mm². The adhesive tensile values of composition Z1, on blasted steel are in the range of 10 N/mm².

The following evaluation was used in Table 3:
[symbol] + [symbol] =adhesive tensile values>8 N/mm²
[symbol] − [symbol] =adhesive tensile values<8 N/mm²

Description Method and Analysis of Fire Protection

In the development, the fire resistance of the composition was first tested according to EN 13501-2 and according to the test method from EN 13381-8:2010. The compositions Z1 and Z4 showed a good insulation effect against the heat input onto the substrate and good stability against falling off or flying away due to turbulence in the fire. This has been given a rating of (+) in Table 3. Compositions which had a reduced insulation effect and/or stability were given a rating of (−).

TABLE 3
compositions of component B and measurement results, quantitative data in parts (weight), n.d. = not determined.

| | Z1 | Rf. 1 | Z2 | Rf. 2 | Z3 | Rf. 3 | Rf. 4 | Rf. 5 | Rf. 6 | Z4 | Rf. 7 |
|---|---|---|---|---|---|---|---|---|---|---|---|
| Component B | | | | | | | | | | | |
| Adduct B1 | 17.5 | 0 | 17.5 | 17.5 | 17.5 | 2.9 | 17.5 | 17.5 | 17.5 | 17.5 | 17.5 |
| Diamine B2-1 | 25 | 25 | 10 | 25 | 25 | 25 | 13 | 25 | 25 | 10 | 25 |
| Diamine B2-2 | | | | | | | | | | 15 | |
| Diamine B3 | 45 | 45 | 45 | 0 | 45 | 45 | 45 | 10 | 45 | 45 | |
| MXDA | | | | | | | | | | | 45 |
| Tertiary | 10 | 10 | 10 | 10 | 0 | 10 | 10 | 10 | | 10 | 10 |
| amine B4 | | | | | | | | | | | |
| Salicylic acid | | | | | | | | | 10 | | |
| Total (parts) | 97.5 | 80 | 82.5 | 52.5 | 87.5 | 82.9 | 85.5 | 62.5 | 97.5 | 97.5 | 97.5 |
| Weight ratio | 1:1.4:2.6:0.6 | | 1:0.6:2.6:0.6 | 1:1.4:0:0.6 | 1:1.4:2.6:0 | 1:8.6:15.5:3.4 | 1:0.7:2.6:0.6 | 1:1.4:0.6:0.6 | | 1:1.4:2.6:0.6 | |
| B1:B2:B3:B4 | | | | | | | | | | | |
| Adhesion | + | − | + | + | + | − | + | + | + | + | n.d. |
| Viscosity | ++ | + | − | − | + | + | − | − | − | + | − |
| Weathering | + | − | − | + | + | − | − | + | − | − | + |
| Fire Protection | + | − | − | − | n.d. | − | − | − | n.d. | + | n.d. |

What is claimed is:

1. A fire protection composition comprising a component A and a component B;
wherein the component A comprises:
10-70 wt % of at least one liquid epoxy resin having an average of more than one epoxy group per molecule A1 based on the total weight of the component A;
10-70 35-45 wt % ammonium polyphosphate A2, based on the total weight of the component A,
and the component B comprises:
at least one adduct B1 from (i) at least one polyamine having at least three amine hydrogens reactive toward epoxide groups with (ii) at least one epoxy:
at least one aliphatic primary diamine B2 containing ether groups;
at least one aliphatic or cycloaliphatic primary diamine B3;
preferably at least one tertiary amine B4,
wherein the weight ratio of B1:B2:B3=1:1.0-2.0:1.5-3.5.

2. The fire protection composition of claim 1, wherein the weight ratio of B1 is: B2:B3:B4=1:1.0-2.0:1.5-3.5:0.15-1.2.

3. The fire protection composition of claim 1, wherein the epoxy liquid resin A1 having on average more than one epoxy group per molecule has the formula (I) 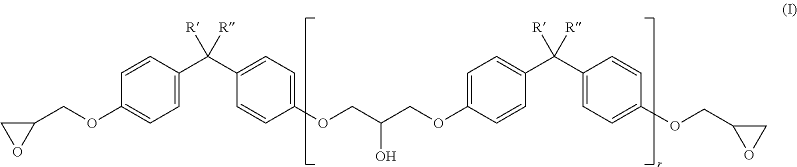
wherein the substituents R′ and R″ independently of one another represent either H or CH₃, and the index r represents a value of 0 to 1.

4. The fire protection composition of claim 1, wherein component A has 1-15 wt % of at least one epoxy group-bearing reactive diluent A3 selected from the group consisting of hexanediol diglycidyl ether, cresyl glycidyl ether, p-tert-butylphenyl glycidyl ether, polypropylene glycol diglycidyl ether and polyethylene glycol diglycidyl ether, based on the total weight of component A.

5. The fire protection composition of claim 1, wherein component A has 1-10 wt. % of at least one triaryl phosphoric acid ester or trialkyl phosphoric acid ester A4 selected from the group consisting of trimethyl phosphate, triethyl phosphate, triisobutyl phosphate, tributyl phosphate, tris-2-chloroethyl phosphate, tris-2-ethyl-hexyl phosphate, tris-2-butoxyethyl phosphate, most preferably triisobutyl phosphate, based on the total weight of component A.

6. The fire protection composition of claim 1, wherein component A has at least 1-10 wt % of at least one acrylate A5 having an acrylate functionality of at least 2, based on the total weight of component A.

7. The fire protection composition of claim 1, wherein adduct B1 is an adduct of (i) at least one polyamine having at least three amine hydrogens reactive toward epoxide groups selected from the group consisting of ethylenediamine, propylenediamine and butylenediamine with (ii) at least one aromatic monoepoxide.

8. The fire protection composition of claim 1, wherein the at least one ether group-containing aliphatic primary diamine B2 has an average molecular weight of 200-600 g/mol.

9. The fire protection composition of claim 1, wherein the at least one aliphatic or cycloaliphatic primary diamine B3 is a cycloaliphatic primary diamine, in particular 1,3-bis(aminomethyl)cyclohexane.

10. The fire protection composition of claim 1, wherein the at least one tertiary amine B4 is a Mannich Base.

11. The fire protection composition of claim 1, wherein the (ii) at least one epoxide of the adduct B1 is aromatic monoepoxide.

12. The fire protection composition of claim 1, wherein the two components A and B, in particular before the use of the fire protection composition, are present as components separated from one another.

13. A coated heat-stable article, comprising the fire protection composition of claim 1 applied to a metal substrate.

14. A method for coating heat-stable substrates, comprising the steps of
i) applying a fire protection composition according to claim 1 to the surface of a heat-stable substrate S1 in order to obtain a coated heat-stable substrate S1;
ii) heating of the coated heat-stable substrate S1 to a temperature of 140-220° C. for 10-60 min.

15. The method according to claim 14, wherein before step i) and step ii) a step i′) is carried out, wherein the coated heat-stable substrate S1 is brought into contact with a CDC coating solution at a temperature between 20 and 100° C. for 1-15 min.

16. The method according to claim 14, wherein before step i) the heat-stable substrate S1 does not undergo any pretreatment at the locations of the surface of the heat-stable substrate S1 on which the fire protection composition is applied in step i).

17. The method according to claim 14, wherein after step i) the applied fire protection coating has a layer thickness of 0.1-4 mm.
